(19) United States
(12) Patent Application Publication
(10) Pub. No.: US 2007/0055558 A1
(43) Pub. Date: Mar. 8, 2007

(54) Method and apparatus for probabilistic workflow mining

(76) Inventors: James G. Shanahan, San Francisco, CA (US); Ricardo Silva, London (GB); Jiji Zhang, Pasadena, CA (US)

Correspondence Address: JONES DAY, 51 Louisiana Avenue N.W., Washington, DC, 20001-2113, US

(21) Appl. No.: 11/506,844

(22) Filed: Aug. 21, 2006

Related U.S. Application Data
(60) Provisional application No. 60/709,434, filed on Aug. 19, 2005.

(51) Int. Cl. G06F 17/50

(52) U.S. Cl. 705/7

(57) ABSTRACT

A method and processing system for generating a workflow graph from empirical data of a process are described. Data for multiple instances of a process are obtained, the data including information about task ordering. The processing system analyzes occurrences of tasks to identify order constraints. A set of nodes representing tasks is partitioned into a series of subsets, where no node of a given subset is constrained to precede any other node of the given subset unless said pair of nodes are conditionally independent given one or more nodes in an immediately preceding subset, and such that no node of a following subset is constrained to precede any node of the given subset. Nodes of each subset are connected to nodes of each adjacent subset with edges based upon the order constraints and based upon conditional independence tests applied to subsets of nodes, thereby providing a workflow graph.

This application claims the benefit under 35 U.S.C.§ 119(e) of U.S. Provisional Patent Application No. 60/709,434 “Method and Apparatus for Probabilistic Workflow Mining” filed Aug. 19, 2005, the entire contents of which are incorporated herein by reference.

### BACKGROUND

1. Field of the Invention

The present disclosure relates to a method and apparatus for generating a workflow graph. More particularly, the present disclosure relates to a computer-based method and apparatus for automatically identifying a workflow graph from empirical data of a process using probabilistic analysis.

2. Background Information

Over time, individuals and organizations implicitly or explicitly develop processes to support complex, repetitive activities. In this context, a process is a set of tasks that must be completed to reach a specified goal. Examples of goals include manufacturing a device, hiring a new employee, organizing a meeting, completing a report, and others. Companies are strongly motivated to optimize business processes along one or more of several possible dimensions, such as time, cost, or output quality.

Many business processes can be modeled with workflows. As used herein, a workflow is a model of a set a tasks with order constraints that govern the sequence of execution of the tasks. A workflow can be represented with a workflow graph, which, as referred to herein, is a representation of a workflow as a directed graph, where nodes represent tasks and edges represent order constraints and/or task dependencies. Traditionally, in business processes where workflows are utilized, the workflows are designed beforehand with the intent that tasks will be carried out in accordance with the workflow. However, businesses often carry out their activities without the benefit of a formal workflow to model their processes. In such instances, development of a workflow could provide a better understanding of the business processes and provide a step towards optimization of those processes. However, development of a workflow by hand based on human observations can be a formidable task.

U.S. Pat. No. 6,038,538 to Agrawal, et al., discloses a computer-based method and apparatus that constructs models from logs of past, unstructured executions of given processes using transitive reduction of directed graphs.

The present inventors have observed a further need for a computer-implemented method and system for identifying a workflow based on an analysis of the underlying empirical data associated with the execution of tasks in actual processes used in business, manufacturing, testing, etc., that is straightforward to implement and that operates efficiently.

### SUMMARY

The present disclosure describes systems and methods that can automatically generate a workflow and an associated workflow graph from empirical data of a process using a layer-building approach that is straightforward to implement and that executes efficiently. The systems and methods described herein are useful for, among other things, providing workflow graphs to improve the understanding of processes used in business, manufacturing, testing, etc. Improved understanding of such processes can facilitate optimization of those processes. For example, given a workflow model for a given process discovered as disclosed herein, the tasks of the workflow model can be adjusted (e.g., orders and/or dependencies of tasks can be changed) and the impact of such adjustments can be evaluated based on simulation data.

According to one exemplary embodiment, a method for generating a workflow graph comprises obtaining data corresponding to multiple instances of a process, the process including a set of tasks, the data including information about order of occurrences of the tasks; analyzing the occurrences of the tasks to identify order constraints among the tasks; partitioning a set of nodes representing tasks into a series of subsets, such that no node of a given subset is constrained to precede any other node of the given subset unless said pair of nodes are conditionally independent given one or more nodes in an immediately preceding subset, and such that no node of a following subset is constrained to precede any node of the given subset; and connecting one or more nodes of each subset to one or more nodes of each adjacent subset with an edge based upon the order constraints and based upon conditional independence tests applied to subsets of nodes, thereby constructing a workflow graph representative of the process wherein nodes represent tasks and nodes are connected by edges.

According to another exemplary embodiment, a system for generating a workflow graph comprises a processing system and a memory coupled to the processing system, wherein the processing system is configured to execute the above-noted steps.

According to another exemplary embodiment, a computer-readable medium comprises executable instructions for generating a workflow graph, wherein the executable instructions comprise instructions adapted to cause a processing system to execute the above-noted steps.

### BRIEF DESCRIPTION OF THE FIGURES

FIG. 1 represents a workflow graph for an exemplary process comprising a set of tasks.

FIG. 2 illustrates an example of cyclic tasks.

FIG. 3 illustrates an exemplary workflow subgraph involving an optional task.

FIG. 4 illustrates an exemplary workflow subgraph for an optional task using an OR formulation.

FIG. 5 illustrates an exemplary workflow subgraph that contains ordering links between nodes in different branches.

FIG. 6 illustrates a flow diagram of a method for generating a workflow graph according to an exemplary embodiment.

FIG. 7A illustrates hypothetical data for the times at which tasks occur for multiple instances of a process.

FIG. 7B illustrates an ordering summary of tasks associated with the hypothetical data of FIG. 7A.

FIG. 7C illustrates an order matrix representative of the hypothetical data of FIG. 7A and ordering summary of FIG. 7B.

FIG. 7D illustrates an alternative order matrix representative of the hypothetical data of FIG. 7A and ordering summary of FIG. 7B.

FIG. 7E illustrates an order data matrix representative of the hypothetical data of FIG. 7A from which order occurrence information and order constraints can be derived.

FIG. 8 illustrates a flow diagram of an exemplary method for connecting nodes in a current subset with nodes in a next subset.

FIG. 9 illustrates a flow diagram of an exemplary method for connecting a node in a next subset to an ancestor node in the current subset depending upon an independence test.

FIG. 10 illustrates a block diagram of an exemplary computer system for implementing the exemplary approaches described herein.

FIG. 11 illustrates an exemplary workflow graph of a hypothetical true process in connection with a hypothetical example.

FIG. 12 illustrates a directionality graph representing a set of nodes G with directed edges inserted between pairs of nodes based upon order constraints of an ordering oracle in connection with the hypothetical example of FIG. 11.

FIGS. 13-17 illustrate partial graphs at various levels of construction representing various stages in an analysis of generating a workflow graph in connection with the hypothetical example of FIG. 11.

FIG. 18 illustrates a resulting workflow graph that can be generated according to methods described herein, which reproduces the true expected workflow graph in connection with the hypothetical example of FIG. 11.

### DETAILED DESCRIPTION

The present disclosure describes exemplary methods and systems for finding an underlying workflow of a process and for generating a corresponding workflow graph, given a set of cases, where each case is a particular instance of the process represented by a set of tasks. In addition to deriving a workflow from scratch, the approach can be used to compare an abstract process design or specification to the derived empirical workflow (i.e., a model of how the process is actually carried out).

Graph Model Overview

To illustrate some basic concepts and terminology utilized in connection with the graph model associated with the subject matter disclosed herein, a simple example will be described. Input data used for identifying a workflow is a set of cases (also referred to as a set of instances). Each case (or instance) is a particular observation of an underlying process, represented as an ordered sequence of tasks. A task as referred to herein is a function to be performed. A task can be carried out by any entity, e.g., humans, machines, organizations, etc. Tasks can be carried out manually, with automation, or with a combination thereof. A task that has been carried out is referred to herein as an occurrence of the task. For example, two cases (C1 and C2) for a process of ordering and eating a meal from a fast food restaurant might be:

(C1) stand in line, order food, order drink, pay bill, receive meal order, eat meal at restaurant (in that order);

(C2) stand in line, order drink, order food, pay bill, receive meal order, eat meal at home (in that order). Data corresponding to a collection of cases may be referred to herein as a case log file, a case log, or a workflow log.

As reflected above, data for cases can be represented as triples (instance, task, time). In this example, triples are sorted first by instance, then by time. Exact time need not be represented; sequence order reflecting relative timing is sufficient (as illustrated in this example). Of course, actual time could be represented if desired, and further, both a start time and an end time could be represented in a case log.

For simplicity, each task can be treated as granular, meaning that it cannot be decomposed, and the time required to complete a task need not be modeled. With such treatment, there are no overlapping tasks. Task overlap can be modeled by treating the task start and the task end as separate sub-tasks in the graph model. Any more complex task can be broken down into sub-tasks in this manner. In general, task decomposition may be desirable if there are important dependency relations to capture between one or more of the sub-tasks and some other external task.

The case log file provides the primary components—tasks and order data—for deriving a workflow from empirical data. A goal is to derive a workflow graph that correctly models dependency constraints between tasks in the process. Since dependency constraints are not directly observed in data of the type illustrated above, order constraints serve as the natural surrogate for them. Some order constraints will reflect true dependency constraints, some will simply represent standard practice, and some will occur by chance. As a general matter, a process expert can distinguish between these situations based upon a review of the output workflow produced by the methods described herein in view of some understanding of the underlying process.

The framework for the graph model involves layer-by-layer graph building. Each graph is built up from layers of nodes. A node is a minimal graph unit and simply represents a task. Nodes are connected via edges that denote temporal relationships between tasks. Three basic operations can link together nodes or more complex graphs: the sequence operation, the AND operation, and the OR operation.

The sequence operation (→) links a series of graphs together with strict order constraints. For example, consider the following nodes: SL=stand in line, PB=pay bill, and RM=receive meal. Then graph G1=SL→PB, graph G2=PB→RM, and graph G3=SL→PB→RM are all valid sequence graphs, because SL always precedes PB, which always precedes RM. Similarly, graph G4=G1→RM and graph G5=SL→G2 are valid sequence graphs with one level of nesting, and the graphs G3, G4, and G5 are functionally equivalent. The sequence operation (→) between a pair of graphs indicates that the parent graph (on the left) always precedes the child graph (on the right), e.g., SL →PB in the example above. Such ordering requirements may also described herein using an order constraint symbol (<), e.g., SL<PB.

When used to describe connections between nodes or graphs herein, the sequence operation reflects a strict order constraint, as noted above. However, it will be appreciated that the sequence operation (→) may also be used herein in describing the particular order between actual occurrences of tasks. In such usage, the sequence operation does not necessarily reflect a strict order constraint for those tasks generally, but instead simply represents an observed order for that occurrence. As will be discussed elsewhere herein, an analysis of the sequences of actual occurrences of tasks can be used to determine whether strict order constraints are generally applicable for given types of tasks.

Nodes in the graph are linked together by order constraints. In practice, the order constraints encoded will sometimes indicate dependency structure (e.g., the task on the right cannot be done before the task on the left), but not always. Order constraints in a process may result from many reasons: tradition, habit, efficiency, or too few observed cases. As noted previously, a process expert with some understanding of the underlying process can determine whether order constraints represent true task dependency or not.

The graph model includes nodes that represent tasks that are not subject to strict sequential order. Non-sequential task structure is modeled with a branching operator, which may also be referred to herein as a split node. Branches have a start or split point and an end or join point. Between the start and end points are two or more parallel threads of nodes that can be executed. Each of these parallel threads of nodes can be referred to as a “branch.” Two types of branching operation—the AND operation and the OR operation—are described below. Thus, split nodes can be AND nodes or OR nodes. Each operation can be considered a sub-graph. For all branches stemming from such an operation, there are no ordering links between branches.

More formally, a workflow graph G is a tuple<N, E> where N denotes a non-empty set of nodes (or vertices) and E denotes a collection of ordered pairs of nodes. A node is associated with a unique label and can be any one of the following classes:
split node—a node with multiple children; two types of split node are dealt with here—OR-nodes and AND-nodes;
join node—a node with multiple parents; and
simple node—a node with no more than one parent and no more than one child.

An edge, characterizing a temporal constraint, in its most abstract form is an ordered pair of nodes of the form (Source node, Target node), wherein the task represented by the source node needs to finish before the task represented by the target node can begin. This is graphically denoted as (Source-node→Target-Node). Source nodes and target nodes are also referred to herein as parent nodes and child nodes, respectively.

Less formally, split nodes are meant to represent the points where choices are made (e.g., where one of several mutually exclusive tasks are chosen) or where multiple parallel threads of tasks will be spawned. Join nodes are meant to represent points of synchronization. That is, a join node is a task J that, before allowing the execution of any of its children, waits for the completion of all active threads that have J as an endpoint. This property can be referred to as a synchronization property.

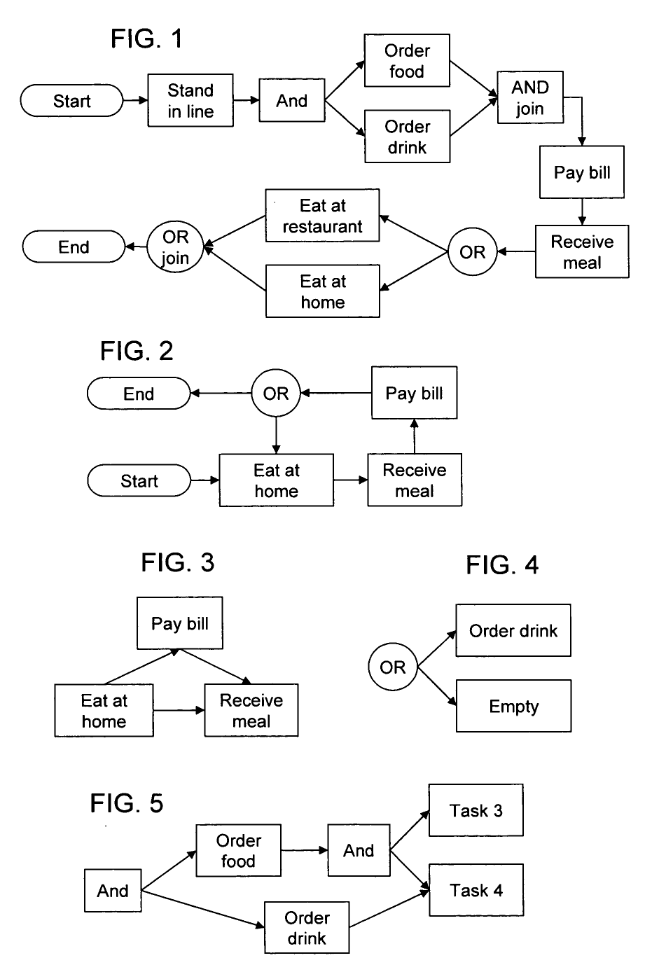

For example, referring to the fast food cases C1 and C2 above, the tasks “order food” and “order drink” (or nodes representing those tasks) can happen in either order. Unordered graphs are partitioned into separate branches using the AND operation. More formally, the AND operation is a branching operation, where all branches must be executed to complete the process. The branches can be executed in parallel (simultaneously), meaning there are no order restrictions on the component graphs or their sub-graphs. The parallel nature of these tasks is reflected in their representation in the graph of FIG. 1, which illustrates a workflow graph representative of the two cases C1 and C2 referred to above. The “order food” and “order drink” branches in this example are basic nodes, but, in general, they could be arbitrary graphs. It will be appreciated that the AND operation can accept any number of branches greater than one.

The graph model also includes tasks that associated with mutually exclusive events. In the fast food example, it can be assumed that it is not possible to both “eat meal at restaurant” and “eat meal at home” for a given meal. Mutually exclusive graphs are partitioned into separate branches using the OR operation. More formally, the OR operation is a branching operation, where exactly one of the branches will be executed to complete the process. FIG. 1 illustrates the exclusive nature of the “eat meal at restaurant” and “eat meal at home” tasks in the fast food example. The branches in this example are, again, basic nodes, but in general, they could be arbitrary graphs. It will be appreciated that the OR operation can accept any number of branches greater than one.

The example of FIG. 1 represents a workflow graph that can be derived by simple inspection of the cases C1 and C2. In general, however, actual business process can be quite complex. The approaches described herein discover how to partition groups of nodes into appropriate sub-graphs automatically. While the basic operations described above are simple in principle, recursive nesting of graphs joined by these operations can produce complex workflows.

The approaches described herein also address incomplete cases. An incomplete case is a process instance where one or more of the tasks in the process are not observed. This can happen for a number of reasons. For example, the process might have been stopped prior to completion, such that no tasks were carried out after the stopping point. Alternatively or in addition, there may have been measurement or recording errors in the system used to create the case logs. This ability of the approaches described herein to address such cases makes the present approaches quite robust.

Extraneous tasks and ordering errors can also be addressed by methods described herein. An extraneous task is a task recorded in the log file, but which is not actually part of the process logged. Extraneous tasks may appear when the recording system makes a mistake, either by recording a task that didn't happen or by assigning the wrong instance label to a task that did happen. An ordering error means that the case log has an erroneous task sequence, such as (A→B) when the true order of the tasks is (B→A). An ordering error may occur if there is an error in the time clock of the recording system or if there is a delay of variable length between when a task happens and when it is recorded, for example.

Extraneous tasks and ordering errors can be addressed, for example, using an algorithm that identifies order constraints that are unusual and that ignores those cases in developing the workflow. For example, if the case log for a process includes the sequence A→B (i.e., task A precedes task B) for 27 cases (instances) and the sequence B→A for two cases, this may indicate an ordering error or an extraneous instance of A or B in those two unusual cases. Eliminating those two cases from further consideration in a workflow analysis may be desirable. Alternatively, as another example, the data could be retained and simply analyzed from a statistical perspective such that if the quantity R=(# of times A occurs before B)/(total # of instances) exceeds a predetermined threshold (e.g., a threshold of 0.7, 0.8, 0.9, etc.), then an order constraint of A<B can be presumed.

As a general matter, it is convenient to assume under the graph model that the workflow graph is acyclical. This is a reasonable assumption in many cases. Nevertheless, various real-world processes involve cyclic activities. In this regard, a cyclic sub-graph is a segment of a graph where one or more tasks are repeated in the process, such as illustrated in the example of FIG. 2. The cyclic link (order constraint) must be part of an OR operation in order for such a process to terminate correctly. Cyclic activities can be addressed in various ways in the context of this disclosure. First, in some cases, it may be possible to define a special cyclic-OR operation that includes a sub-graph (possibly empty) that returns to the node from which it started. Alternatively, the workflow algorithm could create a new task node each time a task is repeated (suitable for processes without large frequent cycles). Another approach is to identify the presence of cyclic tasks using conventional pattern recognition algorithms known to those of ordinary skill in the art, and to replace a subset of data representing a plurality of cyclic tasks with a pseudo-task (e.g., a place holder, such as “cycle 1”) for subsequent analysis along with other task data of such a modified case log file according to the methods described herein. Since the tasks of the basic cyclic unit are identified by the pattern recognition algorithm, suitable graph elements representing these tasks can be readily output by the pattern recognition algorithm for later placement into the derived workflow graph. Other approaches will be described elsewhere herein.

Optional tasks can also be addressed by the approaches described herein. An optional task is a task that is not always executed and has no alternative task (e.g., OR operation) such as illustrated in the example of FIG. 3. One way to address optional tasks, for example, is to extend the functionality of the OR operation to include an empty task, meaning that when the branch with the empty task is followed, nothing is observed in the log. Another way to address optional tasks, for example, is to add a parameter to each task in order to model the probability that the task will be executed in the process.

Optional tasks present an ambiguity. If a given task is not observed, one does not know whether it is optional or whether there is a measurement error, or both. One way to address this consideration is to assign a threshold for measurement error. Thus, if a task is missing at a rate higher than the threshold, then it is considered to be an optional task. Modeling optional tasks with such node probabilities is attractive since including probabilities is also helpful for quantifying measurement error. It will be appreciated that probabilities for missing/optional tasks in a simple OR branch (i.e., all branches consist of a single node) cannot be estimated accurately without a priori knowledge of how to distribute the missing probability mass over the different nodes.

The workflow discovery algorithms described herein assume that branches are either independent or mutually exclusive to facilitate efficient operation, and the use of the two basic branching operations (OR and AND) in that context excludes various types of complex dependency structures from analysis. Stated differently, ordering links between nodes in different branches should be avoided. Of course, real-world systems can exhibit complex dependencies, such as illustrated in the example of FIG. 5. Such complex dependencies can be addressed by reforming the source of the dependency. For example, many such ordering links are caused by incomplete case data, and these cases can be identified and handled as described in elsewhere herein. Also, such complex dependencies can arise by virtue of how tasks are defined and labeled. Labeling tasks too generally can lead to situations where multiple branches recombine at a given task without termination of the multiple branches. Task 4 in FIG. 5 is an example. By labeling tasks more narrowly, it may be possible to recast Task 4 into two different tasks, Task 4A and Task 4B such that the combination of branches at Task 4 in FIG. 5 could be avoided.

In view of the likelihood of task uncertainty, workflows can be modeled in accordance with approaches disclosed herein using a probabilistic framework. This can be done efficiently by decomposing the joint probability distribution of tasks into series of conditional probability distributions (of smaller dimension), where this factorization into smaller conditional probability distributions follows the dependencies specified in the workflow. This decomposition is somewhat similar to Bayesian network decomposition of a joint probability distribution.

With the foregoing overview in mind, exemplary embodiments of workflow discovery algorithms will now be described.

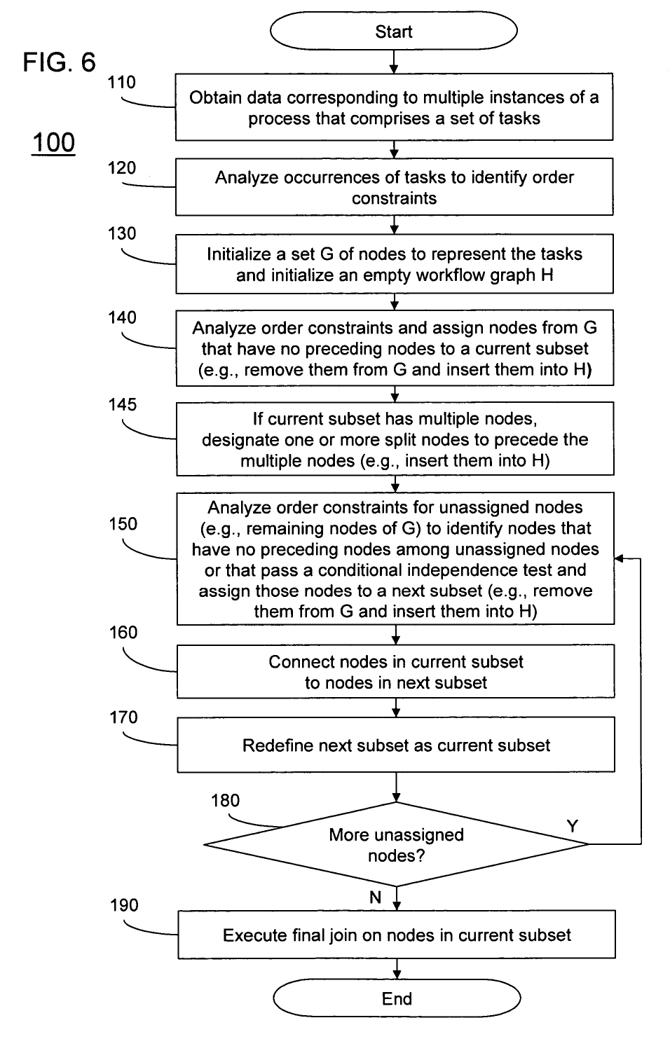

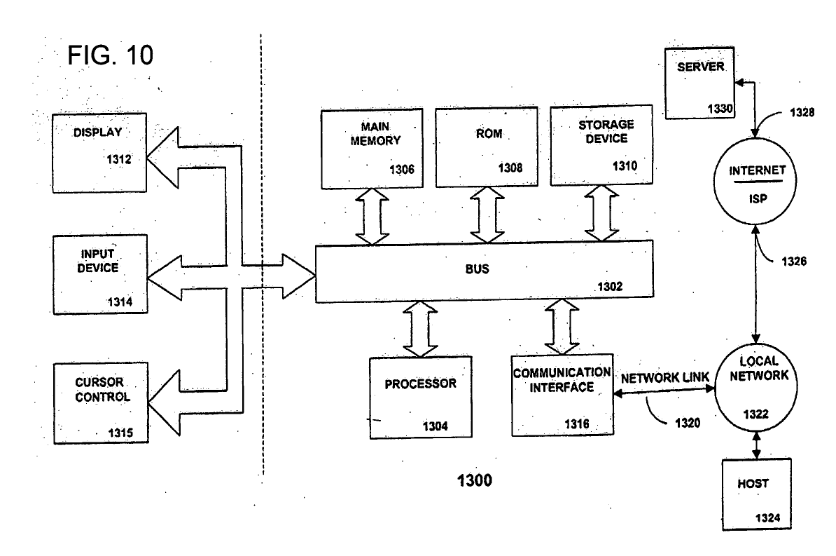

FIG. 6 illustrates a flow diagram for an exemplary method 100 of generating a workflow graph based on empirical data of an underlying process according to an exemplary embodiment. The method 100 can be implemented on any suitable combination of hardware and software as described elsewhere herein. For convenience, the method 100 will be described as being executed by a processing system, such as processor 1304 illustrated in FIG. 10. At step 110 the processing system obtains data corresponding to multiple instances of a process that comprises a set of tasks. This data can be in the form of a case log file as mentioned previously herein, wherein the data are already arranged by case (instance) as well as by task identification (labeling) and time sequence. It is not necessary that this information include the actual timing of the tasks. It is sufficient that tasks of a given case are organized in a manner than indicates their relative time sequence (e.g., task A comes before task B, which comes before task C, etc.). Of course, the exact or approximate time of occurrence of tasks can be provided (e.g., including start and end times), and this information can be used to sort the tasks according to time sequence.

Any suitable technique for generating a case log file can be used, such as conventional methods known to those of ordinary skill in the art. Such case log files can be generated, for instance, by automated analysis (e.g., automated reasoning over free text) of documents and electronic files relating to procurement, accounts receivable, accounts payable, electronic mail, facsimile records, memos, reports, etc. Case log files can also be generated by data logging of automated processes (such as in an assembly line), etc.

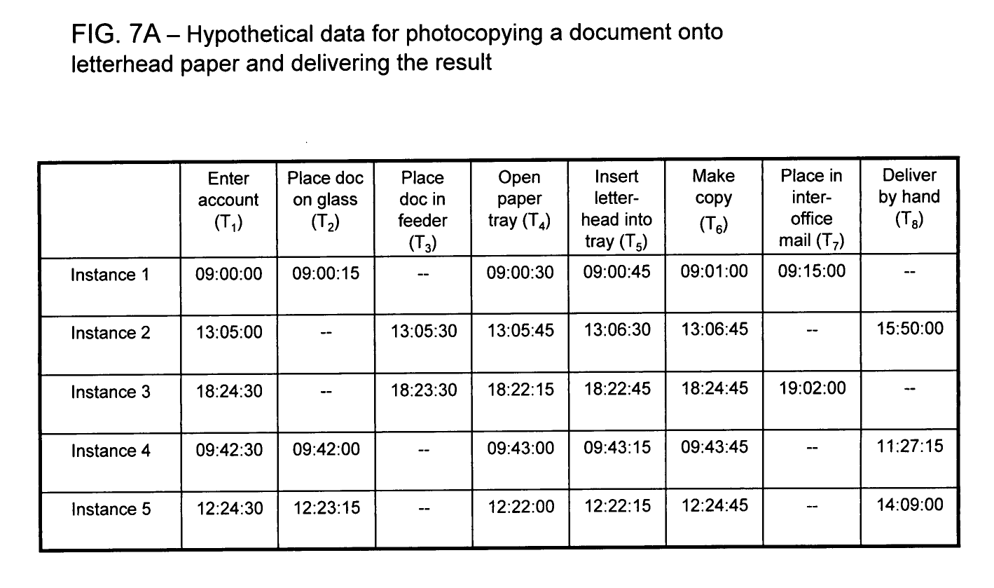

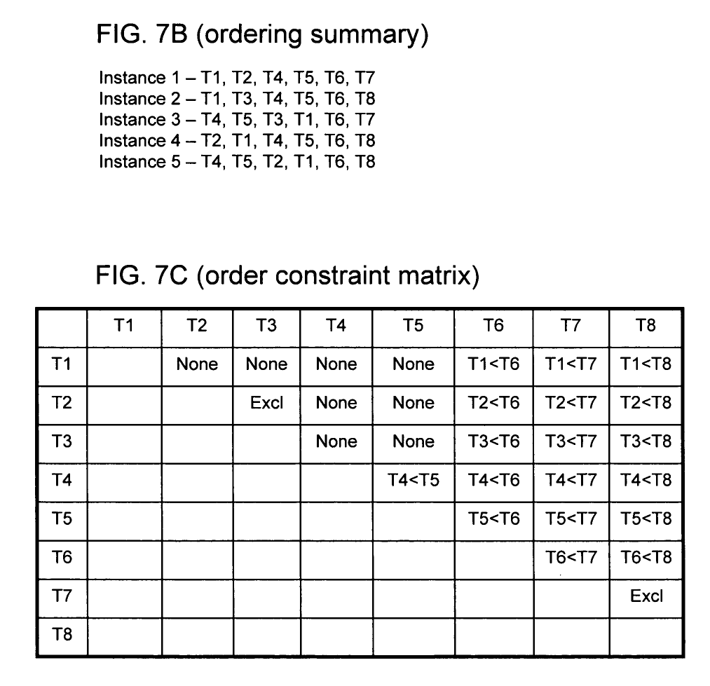

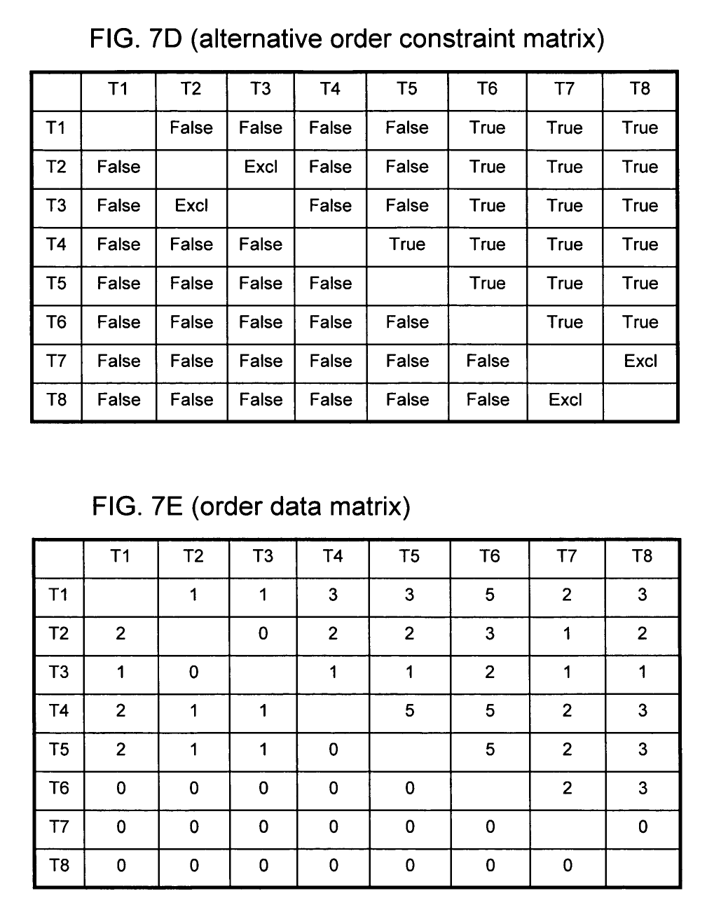

An example of a hypothetical case file is illustrated in FIG. 7A. FIG. 7A illustrates hypothetical data for photocopying a document onto letterhead paper and delivering the result. Data for multiple instances of the process are shown (instance 1, instance 2, etc.). Types of tasks are set forth in columns (enter account, place document on glass, place document in feeder, etc.). The task types are also labeled T₁, T₂ . . . , T₈. Although the task types are numbered in increasing order roughly according to the timing of when corresponding tasks occur, the numerical labeling of task types is entirely arbitrary and need not be based on any analysis of task ordering at this stage. The time at which actual occurrences of tasks occur are reflected in the table of FIG. 7A as illustrated.

FIG. 7B illustrates an ordering summary of the task types associated with the hypothetical data of FIG. 7A. For example, the data for Instance 1 reflects that task T2 occurs after task T1, T4 occurs after T2, T5 occurs after T4, T6 occurs after T5, and T7 occurs after T6. This can be represented in the ordering summary by the simple sequence: T1, T2, T4, T5, T6, T7. It will be appreciated that FIG. 7B can also itself represent a case log file that does not contain numerical time information but instead contains relative timing information for the occurrences of task types. Many variations of suitable case log data and case log files will be apparent to those skilled in the art, and the configuration of case log data is not restricted to examples illustrated herein.

At step 120, the processing system analyzes occurrences of tasks to identify sequence order relationships among the tasks. For example, the processing system can examine the data of the multiple cases to determine, for instance, whether a task identified as task A always occurs before a task labeled as task B in the cases where A and B are observed together. If so, an order constraint A<B can be recorded in any suitable data structure. If task A occurs before task B in some instances and after task B in other instances, an entry indicating that there is no order constraint for the pair A, B can be recorded in the data structure (e.g., “none” can be recorded). If task A is not observed with task B in any instances, an entry indicating such (e.g., “false”) can be recorded in the data structure. This analysis is carried out for all pairings of tasks, and order constraints among the tasks are thereby determined.

An exemplary result of the analysis carried out at step 120 is illustrated in FIG. 7C for the hypothetical data of FIG. 7A. FIG. 7C illustrates an exemplary order constraint matrix that can be used to store the order constraint information determined by analyzing the occurrences of tasks at step 120. As shown in FIG. 7C, the order constraint matrix includes both column and row designations indexed according to task type (e.g., T1, T2, etc.). Inspection of the ordering summary in FIG. 7B reflects that T1 may occur either before or after T2. Accordingly, there is no order constraint between T1 and T2, and the entry for the pair (T1, T2) can be designated with “none” or any other suitable designation. Similarly, there are no order constraints for the pairs T1 and T3, T1 and T4, T1 and T5, T2 and T4, T2 and T5, T3 and T4, and T3 and T5, and these pairs receive entries “none.” Further inspection of the ordering summary of FIG. 7B reflects that T2 and T3 do not occur together in any instance. Accordingly, the entry for the pair T2 and T3 can be designated with the entry “Excl” (exclusive) or with any other suitable designation indicating that these tasks do not occur together. The same is true for the entry for the pair T7 and T8.

Further inspection of the ordering summary of FIG. 7B reveals that for instances in which both T1 and T6 occur, T1 occurs before T6. Accordingly, the entry for the pair T1, T6 can be labeled with a designation T1<T6 (or with any other suitable designation for indicating such an order constraint). Similarly, in all other instances where given pairs occur in the same instance, the ordering summary of FIG. 7B reveals order constraints as indicated in FIG. 7C. As further shown in FIG. 7C, the order constraint matrix need not have entries on both sides of the diagonal of the matrix since the matrix is symmetric. Moreover, the diagonal does not have entries since a given task does not have an order constraint relative to itself. Although the order constraints are illustrated in FIG. 7C as being represented according to a matrix formulation, the order constraint information can be stored in any suitable data structure in any suitable memory. Such data structures may also be referred to herein as “ordering oracles.”

Thus, one exemplary algorithm for identifying order constraints is as follows:
IF (# times Tᵢ<Tⱼ)≠0 AND (# times Tⱼ<Tᵢ)≠0, THEN there is no order constraint between Tᵢ and Tⱼ (e.g., T1 occurs before T4 three times, and T4 occurs before T3 once);
IF (# times Tᵢ<Tⱼ)≠0 AND (# times Tⱼ<Tᵢ)=0, THEN Tᵢ is constrained to occur before Tⱼ (e.g., T1 occurs before T6 five times, and T6 occurs before T1 zero times);
IF (# times Tᵢ<Tⱼ)=0 AND (# times Tⱼ<Tᵢ)=0, THEN Tᵢ and Tⱼ are mutually exclusive (e.g., T3 occurs before T2 zero times, and T2 occurs before T3 zero times).

Another exemplary algorithm “GetOrderingOracle” can identify order constraints by comparing occurrence data to a predetermined threshold, such as follows:

Algorithm GetOrderingOracle

Input: a workflow log L, and a predetermined threshold θ

Output: an ordering oracle for L

1. For every pair of tasks Tᵢ, Tⱼ that appears in the log
a. Let N be the number of instances where Tᵢ=1, Tⱼ=1
b. Let Nᵢ be the number of instances where Tᵢ=1, Tⱼ=1 and Tᵢ appears after Tⱼ
c. Let Nⱼ be the number of instances where Tᵢ=1, Tⱼ=1 and Tⱼ appears after Tᵢ
d. If Nᵢ/N>θ
   i. O(i,j)←true
e. Else
   i. O(i,j)←false
f. If Nⱼ/N>θ
   i. O(j, i)←true
g. Else
   i. O(j, i)←false
h. If (O(i, j)==false) and (O(j, i)==false)
   i. O(i, j)=exclusive
   ii. O(j, i)=exclusive

2. Return O.

The value of θ can be application dependent and can be determined using measures familiar to those skilled in the art (e.g., likelihood of the data), or can be determined empirically by analyzing past data for a given process where order constraints are already known, for example. Other approaches for identifying order constraints will be apparent to those of skill in the art.

FIG. 7D illustrates an alterative exemplary order constraint matrix for which the entries are either True, False, or Excl (exclusive). In this example, a row designation (i) is read against a column designation (j) for the proposition i<j, meaning task i is constrained to occur before task j. If task i is constrained to occur before task j (e.g., task i=T1, task j=T6), the entry is True. If task i is not constrained to occur before task j (e.g., task i=T1, task j=T5), the entry is False. As in FIG. 7C, tasks that do not occur together can be labeled with entries Excl (exclusive).

FIG. 7E illustrates an order data matrix in which the entries represent the actual number of occurrences for which a task i (row designation) occurred before a task j (column designation). The processing system can be programmed to identify whether or not there is an order constraint from such stored data whenever such a determination is required using suitable algorithms, such as described above.

At step 130, the processing system can initialize a set of nodes G to represent the set of tasks and can initialize an empty workflow graph H. The set of nodes can then be placed into the graph layer-by-layer, for example, such as described below.

At step 140, the processing system can analyze the order constraints to identify nodes from the set G that have no preceding nodes (i.e., there are no other nodes constrained to precede them based on the order constraints) and assign them to a current subset. The current subset can also be viewed as a current layer in the layer-by-layer approach for building the workflow graph. The nodes of the current subset could actually be removed from the set G, or they could be appropriately flagged in a data structure in any suitable fashion. For example, these nodes can be removed from G, and they can be inserted into the workflow graph H, meaning that they are now mathematically associated with the workflow graph H.

It should be noted in this regard that the processing system is analyzing nodes that symbolically or mathematically represent types tasks, as opposed to the actual occurrences of tasks, along with corresponding order constraints. As noted previously, the actual occurrences of tasks are instances of tasks actually carried out as reflected by the empirical data in the case log file.

At step 145, the processing system can determine whether a current subset has multiple nodes, and if so, designates one or more split nodes (e.g., AND, OR) to precede the multiple nodes. Such split nodes do not represent actual observable tasks, but rather provide a mechanism for connecting nodes and/or groups of nodes. The processing system can identify whether such split nodes are AND nodes or OR nodes simply by examining the order constraint matrix (or suitable data structure) to determine whether the nodes for those tasks are exclusive (e.g., labeled as “Excl”). If a pair of nodes is designated mutually exclusive, they are joined with an OR split operator, otherwise the pair is joined with an AND split operator. The label “hidden” in this regard is merely a convenient descriptor reflecting the fact that such split nodes do not correspond to observable tasks, that is, they are “hidden” in the observable task data.

At step 150, the processing system analyzes order constraints of unassigned nodes (e.g., the remaining nodes of set G that have not been removed or assigned) to identify nodes among them that have no preceding nodes (i.e., there are no other nodes constrained to precede them based on the order constraints) or that pass a conditional independence test with respect to those preceding nodes, and assigns them to a next subset. The next subset can be viewed as a next layer in the layer-by-layer graph building approach. The nodes of the next subset could actually be removed from the set G, or they could be appropriately flagged in a data structure in any suitable fashion. For example, these nodes can be removed from G, and they can be inserted into the workflow graph H, meaning that they are now mathematically associated with the workflow graph H. For example, the algorithm “GetNextBlanket” described later herein can be used to assign nodes to a next subset. In this manner, for example, the processing system can partition a set of nodes representing tasks into a series of subsets, such that no node of a given subset is constrained to precede any other node of the given subset unless said pair of nodes is conditionally independent given one or more nodes in an immediately preceding subset, and such that no node of a following subset is constrained to precede any node of the given subset.

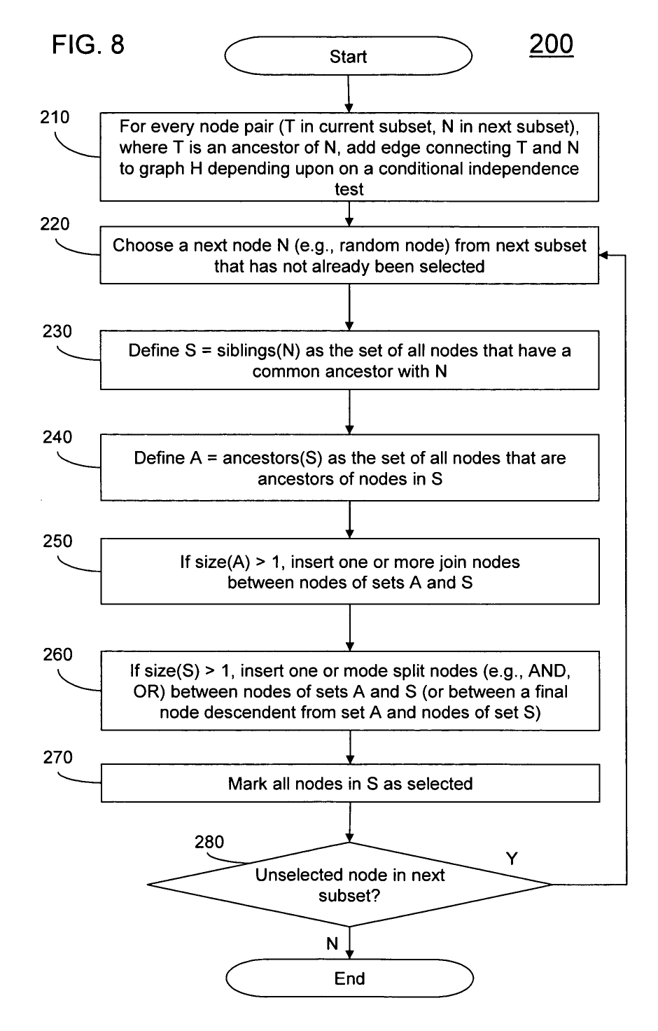

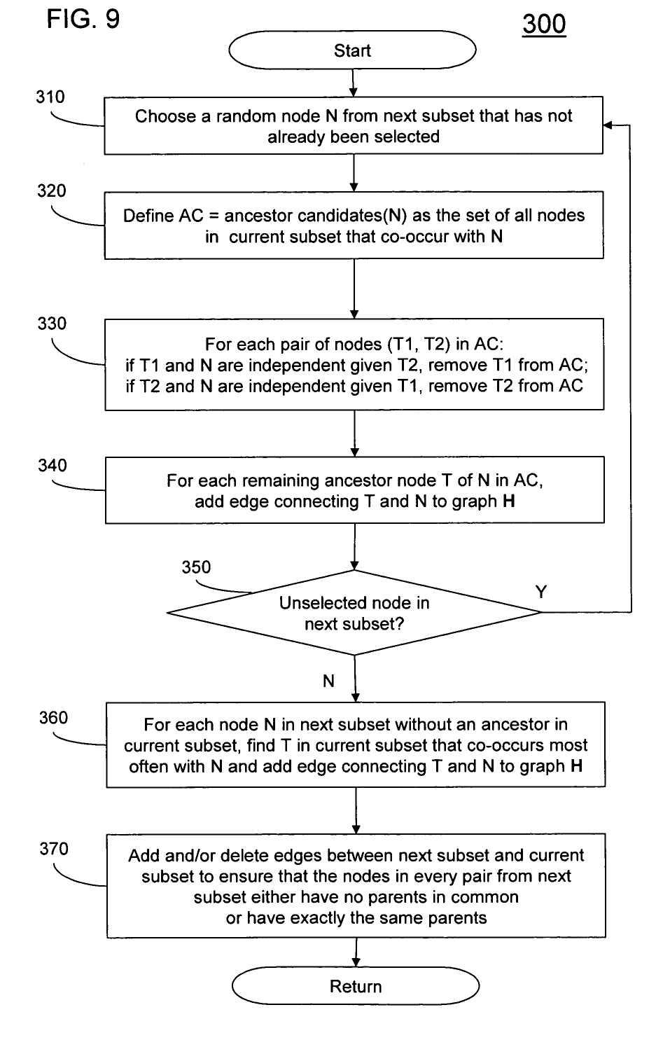

At step 160 the processing system connects nodes in the current subset with nodes in the next subset via directed edges. An exemplary approach for carrying out this step will be described in detail in connection with FIGS. 8 and 9. In this approach, the processing system can connect one or more nodes of each subset to one or more nodes of each adjacent subset with an edge based upon the order constraints and based upon conditional independence tests applied to subsets of nodes (e.g., to be described later herein). In this regard, an adjacent subset is a subset that either immediately precedes or immediately follows a given subset in a sequence in which those subsets are generated, e.g., in a sequence of subsets generated according to consecutive iterations of a loop stemming from decision step 180 (described below).

At step 170 the processing system redefines the next subset as the current subset, and at step 180, determines whether any unassigned nodes remain, e.g., whether the set G has more nodes remaining it. If the answer to the query at step 180 is yes, the process 100 proceeds back to step 150. If the answer to the query at step 180 is no, the process 100 proceeds to step 190, wherein the processing system executes a final join operation to connect the nodes of the current subset (i.e., which is now the final subset) to other nodes with edges. For example, the processing system could join the nodes of the current subset to a single end node via edges, or it could join the nodes of the current subset together such that one of those nodes is the single end node. Join nodes are added in a nested fashion such that such that all the branches of each unterminated split node are connected with a corresponding join node. For example, the two branches in the OR node in FIG. 1 must be connected to a final OR-join node.

Thus, at the completion of step 190, a workflow graph representative of the process has been constructed, wherein the graph is representative of the identified relationships between the nodes of the identified subsets, and wherein the nodes are connected by edges. In such a workflow graph, branches are joined at various levels of nesting using the OR and AND branching operators (split operators) representative of the relationships between nodes, and nodes are connected with edges based on the stored order constraints. It will be appreciated that a graph as referred to herein is not limited to a pictorial representation of a workflow process but includes any representation, whether visual or not, that possesses the mathematical constructs of nodes and edges. In any event, a visual representation of such a workflow graph can be communicated to one or more individuals, displayed on any suitable display device, such as a computer monitor, and/or printed using any suitable printer, so that the workflow graph may be reviewed and analyzed by a human process expert or other interested individual(s) to facilitate an understanding of the process. For example, by assessing the workflow graph generated for the process, such individuals may become of aware of process bottlenecks, unintended or undesirable orderings or dependencies of certain tasks, or other deficiencies in the process. With such an improved understanding, the process can be adjusted as appropriate to improve its efficiency.

As noted above, an exemplary process for connecting nodes as indicated at step 160 of FIG. 6 will now be described with reference to FIG. 8. FIG. 8 illustrates an exemplary method 200 for connecting nodes of the current subset with nodes of the next subset. At step 210, the processing system examines every pair of nodes T, N for which T is an ancestor of N, where T is in the current subset and N in the next subset (as these subsets are currently defined at the present stage of iteration) and adds an edge connecting T and N depending upon an independence test applied to T and N. This step will be described in detail in connection with FIG. 9. At step 220, the processing system chooses a next node N (e.g., a randomly selected node) that has not already been selected from the next subset, meaning that it has not been connected with an edge at step 210. An unselected node is a node that has not been marked in step 270. At step 230, the processing system defines a set S to be the siblings of N, i.e., the set of all nodes that have a common ancestor with N(S=siblings(N)). This set can be identified by straightforward examination of the order constraint matrix (or suitable data structure containing order constraint information). At step 240 the processing system defines a set A to be the ancestors of all the nodes of set S (A=ancestors(S)).

At step 250, the processing system inserts one or more join nodes between nodes of set A and set S if the size of set A is greater than one (i.e., if there is more than one node in set A). The insertion can be done, for example, by executing the algorithm “HiddenJoins” shown below. The joins can be considered “hidden” in the sense that they do not represent observable tasks in the case log.

Algorithm HiddenJoins

Input: H, a workflow graph;

S, a set of nodes;
O, an ordering oracle 0;
   Output: a workflow graph H;
1. (H, NewJoin)←HiddenJoinsStep(H, S, O)
2. Return H
   Algorithm HiddenJoinStep
   Input: H, a workflow graph;
S, a set of nodes;
O, an ordering oracle O;
   Output: H, a workflow graph;
NewLatent, a node;
1. If S has only one element S₀
   a. Return (H, S₀)
2. Let M₁ be a graph having elements of S as nodes, and with an undirected edge between a pair of nodes {S₁, S₂} if and only if O(S₁, S₂)≠exclusive
3. Let M₂ be the complement graph of M₁
4. Let NewLatent be a new latent node, and add NewLatent to H
5. If M₁ is disconnected
   a. M←M₁
   b. Tag NewLatent as “OR-join”
6. else
   c. M←M₂
   d. Tag NewLatent as “AND-join”
7. For each component C in M
   e. If C has only one node C₀
      i. Add C₀→NewLatent to H
   f. Else
      i. (H, NextLatent)←HiddenJoinStep(H, nodesOf(C), O)
      ii. Add NextLatent→NewLatent to H
8. Return (H, NewLatent)

At step 260, if the size of set S is greater than one (i.e., there is more than one node in set S), the processing system inserts one or mode split nodes (e.g., AND, OR) between nodes of sets A and S (or between a final node descendent from set A and nodes of set S). The insertion can be done, for example, by executing the algorithm “HiddenSplits” shown below. The splits can be considered “hidden” in the sense that they do not represent observable tasks in the case log.

Algorithm HiddenSplits

Input: H, a workflow graph;

S, a set of nodes;
O, an ordering oracle O;
   Output: a workflow graph H;
1. (H, NewSplit)←HiddenSplitsStep(H, S, O)
2. Return H
   Algorithm HiddenSplitStep
   Input: H, a workflow graph;
S, a set of nodes;
O, an ordering oracle O;
   Output: H, a workflow graph;
NewLatent, a node;
1. If S has only one element S₀
   a. Return (H, S₀)
2. Let M₁ be a graph having elements of S as nodes, and with an undirected edge between a pair of nodes {S₁, S₂} if and only if O(S₁, S₂)≠ exclusive
3. Let M₂ be the complement graph of M₁
4. Let NewLatent be a new latent node, and add NewLatent to H
5. If M₁ is disconnected
   a. M←M₁
   b. Tag NewLatent as “OR-split”
6. else
   a. M←M₂
   b. Tag NewLatent as “AND-split”
7. For each component C in M
a. If C has only one node C₀
   i. Add C₀←NewLatent to H
b. Else
   i. (H, NextLatent)←HiddenSplitStep(H, nodesOf(C), O)
   ii. Add NextLatent←NewLatent to H
8. Return (H, NewLatent).

At step 270, the processing system marks all the nodes in the set S as “selected.”At step 280, the processing system determines whether there are any unselected nodes remaining in the next subset (as that subset is currently defined under the present iteration). If the answer to the query at step 280 is yes, the process returns to step 220. If the answer to the query at step 280 is no, the process 200 returns to process 100 at step 170.

As noted above, an exemplary process for adding an edge to graph H connecting nodes T and N, where T is an ancestor of N, depending upon an independence test (step 210 of FIG. 8) will now be described with reference to FIG. 9. FIG. 9 illustrates an exemplary method 300 for carrying out step 210 of FIG. 8. At step 310, the processing system chooses a node (e.g., a randomly selected node) N that has not already been designated as “selected” from the next subset (as that subset is defined under the present iteration). At step 320 a set AC of ancestor candidates is defined. The set AC is the set of all nodes in the current subset (as defined under the current iteration) that co-occur with node N (AC=ancestor candidates(N)).

At step 330 the processing system carries out a conditional independence test involving node N and pairs of nodes T₁, T₂ in set AC. Namely, for each pair of nodes T₁, T₂ in set AC, the processing system evaluates whether T₁ and N are independent given the presence of T₂ and whether T₂ and N are independent given the presence of T₁. If T₁ and N are independent given the presence of T₂, the processing system removes the node T₁ from AC (or flags T₁ as “unavailable” or with some other suitable designation). If T₂ and N are independent given the presence of T₁, the processing system removes the node T₂ from AC (or flags T₂ as “unavailable” or with some other suitable designation). For example, the independence test can be carried out using the exemplary algorithm “GetIndpendenceOracle” shown below. Although the steps of the algorithm suggest that the algorithm is carried out for every task Tk that appears in the case log, it will be appreciated that the algorithm can simply be called as necessary to evaluate particular triples of nodes.

Algorithm GetIndependenceOracle

Input: a workflow log L, a threshold θ (e.g., application dependent);

Output: an independence oracle for L

1. For every task Tₖ that appears in the log
a. Let Nₖ be the number of instances where Tₖ=1
b. For every pair of tasks Tᵢ, Tⱼ that appears in the log
   i. Let Nᵢ₁ be the number of instances where Tᵢ=1, Tₖ=1
   ii. Let Nᵢ₀ be the number of instances where Tᵢ=0, Tₖ=1
   iii. Let Nⱼ₁ be the number of instances where Tⱼ=1, Tₖ=1
   iv. Let Nⱼ₀ be the number of instances where Tⱼ=0, Tₖ=1
   v. Let O₀₀ be the number of instances where Tᵢ=0, Tⱼ=0, Tₖ=1
   vi. Let O₀₁ be the number of instances where Tᵢ=0, Tⱼ=1, Tₖ=1
   vii. Let O₁₀ be the number of instances where Tᵢ=1, Tⱼ=0, Tₖ=1
   viii. Let O₁₁ be the number of instances where Tᵢ=1, Tⱼ=1, Tₖ=1
   ix. E₀₀←Nᵢ₀×Nⱼ₀/Nₖ
   x. E₀₁←Nᵢ₀×Nⱼ₁/Nₖ
   xi. E₁₀←Nᵢ₁×Nⱼ₀/Nₖ
   xii. E₁₁←Nᵢ₁×Nⱼ₁/Nₖ
   xiii. G-Square←0
   xiv. For p=1, 2
      1. For q=1, 2
         a. G-Square←chi-Square+2×O_{pq}×log(O_{pq}/E_{pq)}
   xv. If G-Square>θ
      1. I(i, j, k)←false (Tᵢ, is NOT independent of Tⱼ given Tₖ=1)
   xvi. Else
      1. I(i, j, k)←true (Tᵢ, is independent of Tⱼ given Tₖ=1)

2. Return I.

In a variation on the algorithm above, the conditional independence test can utilize the Chi-squared test (more formally written as χ² test) instead of the G-squared test, both of which are well known in the art. This variation differs only in how the empirical values (O_{i,j}) and the expected values (E_{i,j}) are combined in step xiv above, as will be appreciated by those skilled in the art.

At step 340, for each remaining ancestor node T of N in AC (i.e., not removed or flagged “unavailable”), a directed edge is added connecting each node T to node N in graph H. At step 350, the processing system determines whether there remain any unselected nodes in the next subset. If the answer to the query is yes, the process 300 returns to steep 310. If the answer to the query is no, the process continues to step 360. At step 360, for each node N in the next subset without an ancestor in the current subset, the processing system identifies a node T in the current subset that co-occurs most often with the node N and adds an edge connecting that node T with node N in graph H. This “no ancestor” circumstance can occur because it is possible to remove all potential ancestors from the set AC at step 330 if the conditions set forth at step 330 are satisfied. In a variation of this embodiment, it is possible to terminate step 330 before removing the final node from set AC, in which case step 360 could be eliminated.

At step 370, the processing system adds and/or deletes edges between nodes of the current subset and the next subset as necessary to ensure that the nodes in every pair from the next subset either (1) have no parents in common or (2) have exactly the same parents. This step is carried out to maintain a workflow graph that is consistent with the overall graph model, i.e., to avoid ordering links between nodes in different branches.

An exemplary approach for generating a workflow graph from a case log file has been described above in connection with various figures and algorithms. An exemplary algorithm written in pseudo-code with calls to other algorithms for generating a workflow graph will be further described below. The main algorithm is called “LearnOrderedWorkflow” and is shown below. It will be appreciated that the subset CurrentBlanket referred to in the algorithm corresponds to the “current subset” referred to above and that the subset NextBlanket referred to in the algorithm corresponds to the “next subset” referred to above. It will also be appreciated by those skilled in the art that various steps illustrated in FIGS. 6, 8, and 9 can be executed in orders other than those shown, and that the same is true for the exemplary algorithms described below.

Algorithm LearnOrderedWorkflow

Input: O, an ordering oracle for a set T of tasks;

I, an independence oracle for T;

Output: a workflow graph H

1. Set H to be an empty workflow graph (i.e., H has no nodes and no edges); Set G to be a graph that has nodes corresponding to tasks in set T with no edges
2. For every pair of tasks Tᵢ and Tⱼ such that O(T₁, T₂)=true but not O(T₂, T₁) add the edge T₁→T₂ to G_{O}
3. Let CurrentBlanket be the subset of T whose elements do not have a parent in G
4. Add nodes in CurrentBlanket to H
5. H←HiddenSplits(H, CurrentBlanket, O)
6. Remove from G all nodes that are in CurrentBlanket
7. While G has nodes
   a. NextBlanket←GetNextBlanket(CurrentBlanket, G_{O}, O, I)
   b. Add nodes in NextBlanket to H
   c. Ancestors←Dependencies(CurrentBlanket, NextBlanket, O, I)
   d. H←InsertLatents(H, CurrentBlanket, NextBlanket, Ancestors, O)
   e. Remove from G all nodes that are in NextBlanket
   f. Let CurrentBlanket be the subset of T whose elements do not have a child in H
8. H←HiddenJoins(H, CurrentBlanket, O)
9. Return H

The algorithm LearnOrderedWorkflow aims to recover a workflow representative of data of the log file. The algorithm is an iterative layer building algorithm that exploits the data in two ways to establish the layers (subsets) and the links between the successive layers. First, it exploits the data to establish an ordering of tasks (i.e., which tasks co-occur, which tasks are mutually exclusive, which tasks occur before other tasks or in parallel to other tasks). Second, it uses the data to establish conditional independence of two variables X and Y given a third variable Z, denoted mathematically as (X⊥Y|Z), to establish certain types of temporal relationships between tasks.

Two types of information are derived from case log: information about the order of the tasks that can be derived directly from the event sequences, and information about the conditional independences of the tasks. These types of information are derived by two procedures which generate two data structures (referred to as oracles): an ordering oracle, and an independence oracle.

The LearnOrderedWorkflow algorithm accepts as input an ordering oracle O and an independence oracle I, and produces as output a workflow graph H. It will be appreciated that in a variation, the algorithm can call procedures for generating the ordering information and independence information as needed instead of calculating and storing that information for all nodes of the set of nodes at the outset. The workflow graph H is recovered layer-by-layer using information from the ordering oracle and the independence oracle. The algorithm works by iteratively adding child nodes to a partially built graph (corresponding to the partially built workflow graph H) in a specific order. It begins by using the ordering oracle to detect nodes that have no parents (and serve as the “root causes” of all other measurable tasks, i.e., nodes that do not have any measurable ancestors). Such nodes are identified in Step 3 of the LearnOrderedWorkflow procedure. If there is more than one measurable node as a “root cause”, explicit branching nodes (e.g., AND-splits, OR-splits) are added to the graph. This is accomplished by the HiddenSplits procedure (corresponding to step 5 of the LearnOrdered Workflow procedure). Essentially, this procedure assembles the current layer into a partial workflow graph. The remaining steps of the LearnOrderedWorkflow procedure (Steps 7a-7f) involve iteratively identifying successive layers in the workflow graph and appending them to the current version of the workflow. This process continues until all visible nodes have been accounted for in the recovered workflow.

At each iteration (Steps 7a-7f), a set of nodes called CurrentBlanket is determined. This set of nodes contains all of the “leaves” and only the “leaves” of the current workflow graph H, i.e., all the task nodes that do not have any children in H. The initial choice of nodes for CurrentBlanket are exactly the root causes. The next step is to find which measurable tasks should be added to H. The algorithm builds the workflow graph by selecting only a set of tasks NextBlanket such that:
there is no pair (T₁, T₂) in NextBlanket where T, is an ancestor of T₂ in the set of nodes G;
no element in NextBlanket has an ancestor in the set G that is not in workflow graph H; and
every element in NextBlanket has an ancestor in the set G that is in H.

The procedure GetNextBlanket (below) returns a set corresponding to these properties. Identifying which nodes in NextBlanket should be descendants of which nodes in CurrentBlanket is accomplished by the Dependencies procedure.

It is possible that between nodes in CurrentBlanket and nodes in NextBlanket there are hidden join/split nodes. Such nodes are added to H by the InsertLatents algorithm (below).

As noted previously, Steps 7a-7f in the LearnOrderedWorkflow procedure are repeated until all observable tasks are placed in H the workflow graph. To complete the workflow graph, step 8 of LearnOrderedWorkflow ensures that all nodes are synchronized with a final end node. If an end node is not visible, multiple threads will remain open if not joined. This is accomplished by a call to the HiddenJoins procedure (step 8).

Exemplary algorithms for HiddenSplits, HiddenJoins, GetIndependence Oracle (which can generate the independence oracle “I” called in the algorithm above), and GetOrderingOracle (which can generate the ordering oracle “O” called in the algorithm above) have already been described herein. Exemplary algorithms for GetNextBlanket, Dependencies, and InsertLatents called in the main algorithm are provided below.

The GetNextBlanket algorithm (below) identifies suitable nodes of the next layer (or next subset) for the layer-by-layer building of the workflow graph. The GetNextBlanket procedure focuses on the subset of nodes in the remaining set of nodes G referred to previously. The GetNextBlanket procedure can iterate over all pairs of nodes (T₁, T₂) in G such that node T₁ has no parents and such that T₁ precedes T₂ (meaning that T₁ is constrained to precede T₂). The GetNextBlanket procedure can also be implemented to iterate over pairs of nodes (T₁, T₂) in G such that node T₁ has no parents, such that T₁ precedes T₂, and such that the iterations occur over pairs of nodes for which there are no intervening nodes evident from the order constraints of the ordering oracle. If the nodes T₁ and T₂ can co-occur with any task Tᵢ in the current layer (current subset) and T₁ and T₂ are conditionally independent given task Tᵢ then the order constraint for T₁ to precede T₂ is removed (as otherwise this will result in unwanted loops. Mutually exclusive tasks are directly identifiable from the ordering oracle (as the pair of such tasks will never co-occur and consequently no edge will be inserted in the set G).

Algorithm GetNextBlanket

Input: CurrentBlanket, a set of tasks in the current layer (current subset)

G, a set of nodes (derived directly from the log file);
O, an ordering oracle;
I, an independence oracle;
   Output: NextBlanket, a subset of the nodes in G;
1. Add all nodes from G that have no parents in G to NextBlanket
2. For every pair of nodes (T₁, T₂) in G such that T₁ has no parents in G and T₁ precedes T₂
   a. Add node T₂ to NextBlanket if and only if T₁ and T₂ are independent conditioned on Tᵢ=1 according to I, where Tᵢ ε CurrentBlanket and O(Tᵢ, T₁)≠exclusive, O(Tᵢ, T₂)≠exclusive.

While the GetNextBlanket procedure (above) identifies the tasks in the next layer (next subset), it does not indicate which tasks in the current layer are ancestors of the tasks in the newly identified next layer. This is performed by the Dependencies procedure. It is worth noting that the independence oracle needs only to consider conditioning on positive values of a single node T₂ (step 2a of Dependencies).

Algorithm Dependencies

Input: CurrentBlanket, a subset of a set T of nodes;

NextBlanket, another subset of T;
O, an ordering oracle;
I, an independence oracle;
   Output: AncestralGraph, a graph with edges in CurrentBlanket×NextBlanket
1. Let AncestralGraph be a graph with nodes in CurrentBlanket∪NextBlanket
2. For every task T₀ in NextBlanket
   a. For every task T₁ in CurrentBlanket, add edge T₁→T₀ to AncestralGraph if and only if:
      i. T₁ and T₀ can co-occur; can be sequential or parallel, i.e., O(T₀ and T₁)≠exclusive.
      ii. There is no task T₂ in CurrentBlanket such that:
         1. T₁ and T₂ need to co-occur (i.e., not sequential). This should not happen since they are in the same blanket (CurrentBlanket). Algorithmically speaking, {T₁, T₂} are not mutually exclusive according to O, (O(T₀ and T₁) not=exclusive)
         2. T₀ and T₂ need to co-occur (i.e. not sequential) T{T₀, T₂} are not mutually exclusive according to O , (O(T₀ and T₂) not =exclusive)
         3. and T_{0M} and T_{1M} are independent conditioned on T_{2M}=1, where T_{iM} is the measure of task Tᵢ; where it is necessary that T₂ is the parent of both T₁ and T₀.
3. Return AncestralGraph

The algorithm InsertLatents (below) can introduce required nodes between two layers (subsets) of nodes representing observable tasks, as called by the main algorithm LearnOrderedWorkflow (above).

Algorithm InsertLatents

Input a workflow graph H;

CurrentBlanket, NextBlanket (two sets of nodes);
AncestralGraph;
O an ordering oracle;
   Output a workflow graph H
1. For every node T NextBlanket
   a. Let Siblings be the set of elements in NextBlanket that have a common parent with T in AncestralGraph
   b. Let AncestralSet be the set of parents of Siblings in AncestralGraph
   c. (H, JoinNode)←HiddenJoins(H, AncestralSet, O)
   d. (H, SplitNode)←HiddenSplits(H, Siblings, O)
   e. Add edge JoinNode→SplitNode to H
   f. NextBlanket←NextBlanket-Siblings
2. For every set C of observable tasks, |C|>1, that are children of a single hidden node PaH that is child of an observable task Pa in H
   a. If all pairs in C_{M} are independent conditioned on PaM=1, C_{M} being the set of respective measures of C and Pa_{M} the measure of Pa,
      i. Add edges Pa→Cᵢ for every Cᵢ C
      ii. Remove latent Pa_{H}
3. Return H

In another exemplary embodiment alternative embodiment, the possibility of measurement error is addressed. For each node T representing a task that is measurable, the possibility that T is not recorded in a particular instance (or case) even though T happened can be accounted for. That is, let T_{M} be a binary variable such that T_{M}=1 if task T is recorded to happen. Then, the following measurement model is provided:
P(T_{M}=1|T=1)=η_{TM}>0, and
P(T_{M}=1|T=0)=0.

Measurement variables are proxies for the nodes representing actual tasks and allow for errors in recording. Even allowing the possibility of measurement error, the methods described herein can robustly reconstruct a workflow graph.

Additional considerations regarding how to avoid generating invalid workflow graphs, which may arise from anomalies in the data (such as statistical mistakes), will now be discussed. A first consideration involves how to avoid cycles. As noted previously, one approach for addressing cycles is to identify cyclic tasks with pattern recognition and replace the data corresponding to cyclic tasks with a pseudo-task. As another approach, if a cycle is detected in the ordering oracle, the weakest link Tᵢ→Tⱼ in the cycle (according to the frequency of occurrence of (Tᵢ, Tⱼ) in the dataset, where Tᵢ precedes Tⱼ) can simply be removed. This procedure can be iterated until no cycles remain.

A second consideration involves how to guarantee that splits and joins are suitably nested. Appropriate nesting can be accomplished by modifying the ordering and independence oracles, if necessary. For example, if the independence oracle links the current and next layers (subsets) in a such way that the ancestral relations between nodes in the two layers create join nodes that are not nested within previous split nodes (as decided by procedure Dependencies), edges can be added to the graph or removed until the resulting workflow graph has a properly nested structure. First, either graph M1 or M2 in HiddenJoins and HiddenSplits should be examined to determine if either is disconnected. If neither is disconnected, edges can be removed from M1 starting from the least frequent observed pairs until M1 is disconnected.

This is not enough, however, to guarantee consistency with the graph model. As a further step, another algorithm GetParseTree can be called to identify any other edges that should be added. GetParseTree (below) obtains a parse tree from a partially built workflow graph.

Algorithm GetParseTree

Input: a set of nodes S;

a graph H with a set of nodes that includes S;
   Output: a parse tree PT;
1. For every node S in S, let Anc(S) be the ancestor of S in H such that Anc(S) has more than one descendant in S in H, and no descendant of Anc(S) in H has the same property;
2. Let Q be the set of elements in H such that for every QεQ, there is some SεS such that Anc(S)=Q;
3. Let QᵢεQ, and let Cluster(Qᵢ) be the largest subset of descendants of Qᵢ in S such that for every element CεCluster(Qᵢ) there is no QᵢεQ that is a descendant of Qᵢ in H and an ancestor of C;
4. Let PT be a tree formed with nodes Q∪S, and edges Qᵢ→Sⱼ if and only if Sⱼε Cluster(Qᵢ), and Qᵢ→Qₖ if and only if Qᵢ is an ancestor of Qₖ in H;
5. Let Q₀ be the set of nodes in PT that do not have any parent in PT. If Q₀≠ø, let PT₀←GetParseTree(Q₀, H), and add all edges in PT₀ that are not in PT to PT;
6. Return PT.

Let Parents(V, G) represent the set of parents of node V in graph G, and LeastCommonAncestor(S, PT) represent the node T in tree PT that is a common ancestor of all elements in S and has no descendant that is also an ancestor of all elements in S. Notice that if S contains only one element S, then LeastCommonAncestor(S, PT)=S. The level of T in PT is the size of the largest path from T to one of its descendants in S, where the size of a path is the number of edges in this path.

A further structural consideration is necessary to avoid generating invalid graphs. Namely, in the procedure Dependencies, for each pair of observable tasks either the tasks do not have any parent in common in AncestralGraph, or the tasks have exactly the same parents. Also, each task in NextBlanket has at least one parent in AncestralGraph. Finally, let PT be the parse tree for CurrentBlanket. For any node T₀ in NextBlanket, it follows that if LeastCommonAncestor(Parents(T₀, AncestralGraph), PT) has a level of at least 2, then T₀ is a child of every element from Leaves(LeastCommonAncestor(Parents(T₀, AncestralGraph), PT), PT) in AncestralGraph.

If, during the execution of the main algorithm, any of the above conditions fails, then a valid workflow graph will not be generated. In such a case, the following modification of the algorithm Dependencies can be implemented.

Algorithm Dependencies2

Input: G, the current workflow graph

CurrentBlanket, a subset of a set T of tasks;
NextBlanket, another subset of T;
O, an ordering oracle;
I, an independence oracle;
   Output: AncestralGraph, a graph with edges in CurrentBlanket×NextBlanket
1. Let AncestralGraph be a graph with nodes in CurrentBlanket∪NextBlanket
2. For every task T₀ in NextBlanket
   a. For every task T₁ in CurrentBlanket, add edge T₁→T₀ to AncestralGraph if and only if:
      (i) T₁ and T₀ can co-occur; can be sequential or parallel. I.e., O(T₀ and T₁)≠exclusive.
      (ii) There is no task T₂ in CurrentBlanket such that:
         1. T₁ and T₂ need to co-occur (i.e., not sequential). This should not happen since they are in the same blanket (CurrentBlanket). Algorithmically speaking, {T₁, T₂} are not mutually exclusive according to O, (O(T₀ and T₁) not =exclusive)
         2. T₀ and T₂ need to co-occur (i.e. not sequential) T{T₀, T₂} are not mutually exclusive according to O, (O(T₀ and T₂) not=exclusive)
         3. and T_{0M} and T_{1M} are independent conditioned on T_{2M}=1, where T_{iM} is the measure of task Tᵢ; where it is necessary that T₂ is the parent of both T₁ and T₀.
3. For all node Tᵢ in NextBlanket that does not have a parent in AncestralGraph:
   a. Let Tₚ be the node in CurrentBianket that co-occurs more often with Tᵢ
   b. Add edge Tₚ→Tᵢ to AncestralGraph
4. Repeat
   a. For every Tᵢ, Tⱼ in NextBlanket where
      i. If Tᵢ and Tⱼ have some common parent in AncestralGraph, but some parent of Tᵢ is not a parent of Tⱼ or vice-versa
         1. Add edges from all parents of Tᵢ into Tⱼ, and vice-versa
   b. PT←GetParseTree(CurrentBlanket, G)
   c. For every T₀ in NextBlanket
      i. If LeastCommonAncestor(Parents(T₀, AncestralGraph), PT) has a level of at least 2
         1. Make T₀ a child of every element from Leaves(LeastCommonAncestor(Parents(T₀, AncestralGraph), PT), PT) in AncestralGraph
5. Until AncestralGraph remains unmodified
6. Return AncestralGraph

Thus, it will be appreciated that various conditions that might otherwise prevent generating a valid workflow graph can be addressed by the methods described herein.

Hardware Overview

FIG. 10 illustrates a block diagram of an exemplary computer system upon which an embodiment of the invention may be implemented. Computer system 1300 includes a bus 1302 or other communication mechanism for communicating information, and a processor 1304 coupled with bus 1302 for processing information. Computer system 1300 also includes a main memory 1306, such as a random access memory (RAM) or other dynamic storage device, coupled to bus 1302 for storing information and instructions to be executed by processor 1304. Main memory 1306 also may be used for storing temporary variables or other intermediate information during execution of instructions to be executed by processor 1304. Computer system 1300 further includes a read only memory (ROM) 1308 or other static storage device coupled to bus 1302 for storing static information and instructions for processor 1304. A storage device 1310, such as a magnetic disk or optical disk, is provided and coupled to bus 1302 for storing information and instructions.

Computer system 1300 may be coupled via bus 1302 to a display 1312 for displaying information to a computer user. An input device 1314, including alphanumeric and other keys, is coupled to bus 1302 for communicating information and command selections to processor 1304. Another type of user input device is cursor control 1315, such as a mouse, a trackball, or cursor direction keys for communicating direction information and command selections to processor 1304 and for controlling cursor movement on display 1312.

The exemplary methods described herein can be implemented with computer system 1300 for deriving a workflow from empirical data (case log files) such as described elsewhere herein. Such processes can be carried out by a processing system, such as processor 1304, by executing sequences of instructions and by suitably communicating with one or more memory or storage devices such as memory 1306 and/or storage device 1310 where derived workflow can be stored and retrieved, e.g., in any suitable database. The processing instructions may be read into main memory 1306 from another computer-readable medium, such as storage device 1310. However, the computer-readable medium is not limited to devices such as storage device 1310. For example, the computer-readable medium may include a floppy disk, a flexible disk, hard disk, magnetic tape, or any other magnetic medium, a CD-ROM, any other optical medium, a RAM, a PROM, and EPROM, a FLASH-EPROM, any other memory chip or cartridge, or any other medium from which a computer can read, containing an appropriate set of computer instructions that would cause the processor 1304 to carry out the techniques described herein. The processing instructions may also be read into main memory 1306 via a modulated wave or signal carrying the instructions, e.g., a downloadable set of instructions. Execution of the sequences of instructions causes processor 1304 to perform process steps previously described herein. In alternative embodiments, hard-wired circuitry may be used in place of or in combination with software instructions to implement the exemplary methods described herein. Moreover the process steps described elsewhere herein may be implemented by a processing system comprising a single processor 1304 or comprising multiple processors configured as a unit or distributed across multiple machines. Thus, embodiments of the invention are not limited to any specific combination of hardware circuitry and software, and a processing system as referred to herein may include any suitable combination of hardware and/or software whether located in a single location or distributed over multiple locations.

Computer system 1300 can also include a communication interface 1316 coupled to bus 1302. Communication interface 1316 provides a two-way data communication coupling to a network link 1320 that is connected to a local network 1322 and the Internet 1328. It will be appreciated that data and workflows derived there from can be communicated between the Internet 1328 and the computer system 1300 via the network link 1320. Communication interface 1316 may be an integrated services digital network (ISDN) card or a modem to provide a data communication connection to a corresponding type of telephone line. As another example, communication interface 1316 may be a local area network (LAN) card to provide a data communication connection to a compatible LAN. Wireless links may also be implemented. In any such implementation, communication interface 1316 sends and receives electrical, electromagnetic or optical signals which carry digital data streams representing various types of information.

Network link 1320 typically provides data communication through one or more networks to other data devices. For example, network link 1320 may provide a connection through local network 1322 to a host computer 1324 or to data equipment operated by an Internet Service Provider (ISP) 1326. ISP 1326 in turn provides data communication services through the “Internet” 1328. Local network 1322 and Internet 1328 both use electrical, electromagnetic or optical signals which carry digital data streams. The signals through the various networks and the signals on network link 1320 and through communication interface 1316, which carry the digital data to and from computer system 1300, are exemplary forms of modulated waves transporting the information.

Computer system 1300 can send messages and receive data, including program code, through the network(s), network link 1320 and communication interface 1316. In the Internet 1328 for example, a server 1330 might transmit a requested code for an application program through Internet 1328, ISP 1326, local network 1322 and communication interface 1316. In accordance with the present disclosure, one such downloadable application can provide for deriving a workflow and an associated workflow graph as described herein. Program code received over a network may be executed by processor 1304 as it is received, and/or stored in storage device 1310, or other non-volatile storage for later execution. In this manner, computer system 1300 may obtain application code in the form of a modulated wave. The computer system 1300 may also receive data via over a network, wherein the data can correspond to multiple instances of a process to be analyzed in connection with approaches described herein.

Components of the invention may be stored in memory or on disks in a plurality of locations in whole or in part and may be accessed synchronously or asynchronously by an application and, if in constituent form, reconstituted in memory to provide the information used for processing information relating to occurrences of tasks and generating workflow graphs as described herein.

### EXAMPLE

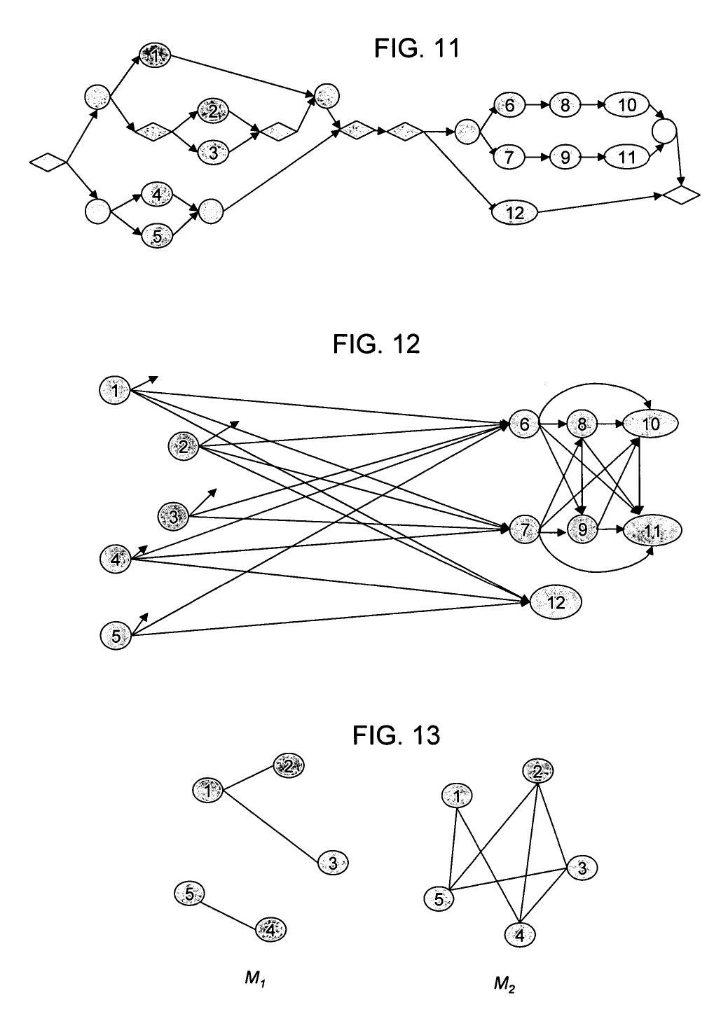

An example of how LearnOrderedWorkflow works will now be described for hypothetical data. Assume for now that the hypothetical graph G in FIG. 11 corresponds to a true generative model, i.e., a true process, from which we know the ordering oracle O and I for tasks {1, . . . , 12}. The following discussion will demonstrate how LearnOrderedWorkflow is able to reconstruct G out of O and I. In this example, numbered circles represent nodes that correspond to tasks, diamond shapes represent OR splits or OR joins, and blank circles represent AND splits or AND joins. Nodes without label represent hidden tasks in the sense that they are not directly observable tasks in the case log file.

Suppose that a directionality graph G is given in FIG. 12, i.e., graph G represents nodes of the set G with directed edges inserted between pairs of nodes based on order constraints of the ordering oracle O. It is not necessary to actually create this graph in carrying out the methods described herein, but it is helpful for understanding the example because it provides a visual indication of the order constraints. Notice that even though elements in {8, 10} are concurrent to elements in {9, 11}, there is a total order among these elements: 8→9→10→11, according to 0.6 and 7 are not connected because by assumption they should happen in either order a frequent number of times. We consider this assumption to be reasonable (at the moment of the split, tasks should be independent, and therefore no fixed time order implied). However, contrary to a naive workflow mining algorithm, we do not require, for instance, that 6 and 11 are recorded in random orders. Thus, FIG. 12 represents an ordering relationship for the graph in FIG. 8. Edges between elements in {1, 2, 3, 4, 5} and {8, 9, 10, 11} are not explicitly shown in order to avoid cluttering the graph. The indication of extra edges is symbolized by the unconnected edges out of elements in {1, 2, 3, 4, 5}.

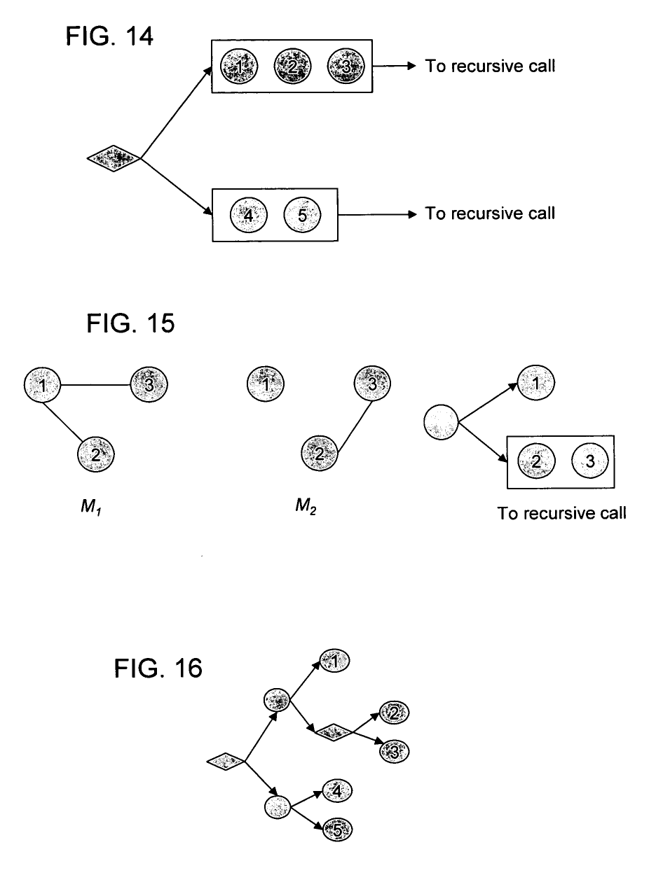

In the initial step, the set CurrentBlanket will contain tasks {1, 2, 3, 4, 5}. The HiddenSplits algorithm will work as follows: two graphs, M₁ and M₂, will be created based on O and tasks {1, 2, 3, 4, 5}. These graphs are shown in FIG. 13. Since M₁ is disconnected, it will be the basis for the recursive call. The algorithm will insert an hidden OR-split separating {1, 2, 3} and {4, 5} at the return of the recursion, as depicted in FIG. 14. Thus, the first call of SplitStep will separate set {1, 2, 3, 4, 5} as {1, 2, 3} and {4, 5} as shown in FIG. 14.

Consider the new call for HiddenSplitStep (see HiddenSplits algorithm herein) with argument S={1, 2, 3}. The corresponding graphs M₁ and M₂ are now shown in FIG. 15. Graphs M₁ and M₂ correspond to S={1, 2, 3} in SplitStep. M₁ is not disconnected, but M₂ is. This will lead to an insertion of an AND-split separating sets {1} and {2, 3} and another recursive call for {2, 3}. At the end of the first HiddenSplits, H will be given by the partially constructed graph shown in FIG. 16. The algorithm now proceeds to insert the remaining nodes into H.

From the ordering graph illustrated in FIG. 12 the algorithm will choose as the next blanket the set {6, 7, 12}. Since these nodes are not connected by any edge in FIG. 15, there is no need to do any independence test to remove edges between them. When computing the direct dependencies between {1, . . . , 5} and {6, 7, 12}, since no conditional independence holds between elements in {6, 7, 12} conditioned on positive measurements of any element in {1, 2, 3, 4, 5}, all elements in {l, 2, 3, 4, 5} will be the direct dependencies of each element in {6, 7, 12}.

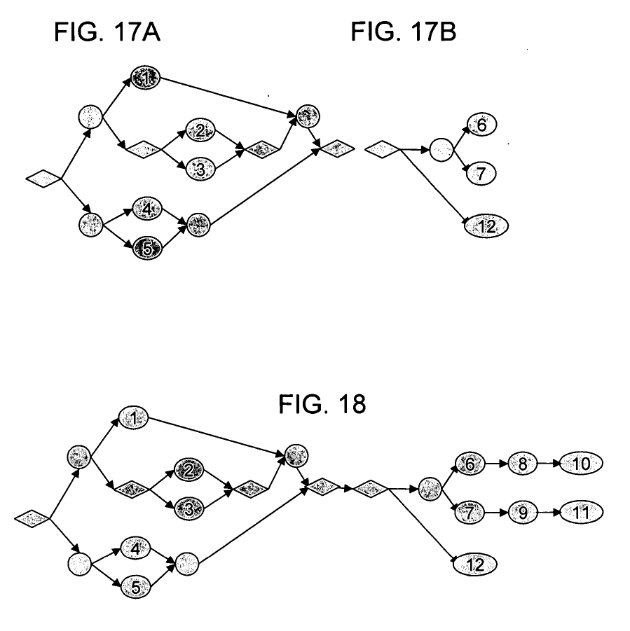

The algorithm now performs the insertion of possible latents between {1, 2, 3, 4, 5} and {6, 7, 12}. There is only one set Siblings in InsertLatents, {6, 7, 12}, and one AncestralSet, {1, 2, 3, 4, 5}. When inserting hidden joins for elements in AncestralSet, the algorithm will perform an operation analogous to the previous example of InsertHiddenSplits, but with arrows directed in the opposite way. The modification is shown in FIG. 17A, while FIG. 17B depicts the modification of the relation between {6, 7, 12}. The last step of the InsertLatents iteration simply connects the childless node of FIG. 17A to the parentless node of FIG. 17B.

The algorithm proceeds to add more observable tasks in the next cycle of LearnOrderedWorkflow. The candidates are {8, 9, 10, 11}. By inspection of FIG. 12, all elements in {8, 9, 10, 11} are connectable by edges without any intervening nodes based upon observed order constraints. However, by conditioning on singletons from {6, 7, 12} the algorithm can eliminate edges {8→9, 9→10, 8→11, 10→11}. The parentless nodes in this set are now 8 and 9, instead of 8 only. CurrentBlanket is now {6, 7, 12} and NextBlanket is {8, 9}.

When determining direct dependencies, the algorithm first selects {6, 7} as the possible ancestors of {8, 9}. Since 8 and 7 are independent conditioned on 6, and 9 and 6 are independent conditioned on 7, only edges 6→8 and 7→9 are allowed. Analogously, the same will happen to 8→10 and 9→11. Graph H, after introducing all observable tasks, is shown in FIG. 18. Thus, after introducing the last hidden joins in the final steps of LearnOrderedWorkflow, it can be seen that the algorithm reconstruct exactly the original graph shown in FIG. 11.

While this invention has been particularly described and illustrated with reference to particular embodiments thereof, it will be understood by those skilled in the art that changes in the above description or illustrations may be made with respect to form or detail without departing from the spirit or scope of the invention.

What is claimed is:

1. A method for generating a workflow graph representative of a process to facilitate an understanding of the process, the method comprising:
(a) obtaining data corresponding to multiple instances of a process, the process including a set of tasks, the data including information about order of occurrences of the tasks;
(b) analyzing the occurrences of the tasks to identify order constraints among the tasks;
(c) partitioning a set of nodes representing tasks into a series of subsets, such that no node of a given subset is constrained to precede any other node of the given subset unless said pair of nodes are conditionally independent given one or more nodes in an immediately preceding subset, and such that no node of a following subset is constrained to precede any node of the given subset; and
(d) connecting one or more nodes of each subset to one or more nodes of each adjacent subset with an edge based upon the order constraints and based upon conditional independence applied to subsets of nodes, thereby constructing a workflow graph representative of the process wherein nodes represent tasks and nodes are connected by edges.

2. The method of claim 1:
wherein step (c) comprises
(e) analyzing the order constraints to identify one or more nodes that have no preceding nodes, and assigning the one or more nodes to a current subset, wherein nodes other than those assigned are unassigned nodes, and
(f) analyzing the order constraints for the unassigned nodes to identify one or more further nodes that have no preceding nodes from among the unassigned nodes or pass a conditional independence test with respect to those preceding nodes, assigning the one or more further nodes to a next subset, and updating the unassigned nodes; and
wherein step (d) comprises
(g) connecting a node of the current subset to a node of the next subset based upon the order constraints and based upon conditional independence tests applied to pairs of nodes from the current subset and the node of the next subset.

3. The method of claim 2, comprising: while any unassigned nodes remain, redefining the next subset as the current subset, and repeating steps (f) and (g) with a new next subset.

4. The method of claim 2, wherein step (g) comprises adding an edge between a node of the current subset and a node of the next subset for which the node of the current subset is constrained to precede the node of the next subset and for which the node of the current subset and the node of the next subset are not conditionally independent given a second node from the current subset.

5. The method of claim 2, wherein step (g) comprises adding an edge between a node of the current subset and a node of the next subset for which the node of the current subset is constrained to precede the node of the next subset and for which the node of the current subset and the node of the second subset are those that represent tasks that co-occur most often.

6. The method of claim 2, comprising adding and/or deleting edges between nodes to ensure that every pair of nodes in the next subset has either exactly the same set of parents in the current subset or no parents in common in the current subset.

7. The method of claim 2, wherein step (d) comprises adding join nodes and split nodes to thereby connect selected nodes of the set of nodes.

8. The method in claim 7, wherein the split nodes separate subsets of nodes such that either:
nodes in each subset represent tasks that are executable in parallel without order constraints relative to tasks represented nodes of another subset; or
nodes in each subset represent tasks are mutually exclusive.

9. A system for generating a workflow graph representative of a process to facilitate an understanding of the process, comprising:
a processing system; and
a memory coupled to the processing system, wherein the processing system is configured to:
(a) obtain data corresponding to multiple instances of a process, the process including a set of tasks, the data including information about order of occurrences of the tasks;
(b) analyze the occurrences of the tasks to identify order constraints among the tasks;
(c) partition a set of nodes representing tasks into a series of subsets, such that no node of a given subset is constrained to precede any other node of the given subset unless said pair of nodes are conditionally independent given one or more nodes in an immediately preceding subset, and such that no node of a following subset is constrained to precede any node of the given subset; and
(d) connect one or more nodes of each subset to one or more nodes of each adjacent subset with an edge based upon the order constraints and based upon conditional independence tests applied to subsets of nodes, thereby constructing a workflow graph representative of the process wherein nodes represent tasks and nodes are connected by edges.

10. The system of claim 9:
wherein to execute step (c), the processing system is configured to
(e) analyze the order constraints to identify one or more nodes that have no preceding nodes, and assigning the one or more nodes to a current subset, wherein nodes other than those assigned are unassigned nodes, and
(f) analyze the order constraints for the unassigned nodes to identify one or more further nodes that have no preceding nodes from among the unassigned nodes or pass a conditional independence test with respect to those preceding nodes, assigning the one or more further nodes to a next subset, and updating the unassigned nodes; and
wherein to execute step (d), the processing system is configured to
(g) connect a node of the current subset to a node of the next subset based upon the order constraints and based upon conditional independence tests applied to pairs of nodes from the current subset and the node of the next subset.

11. The system of claim 10, wherein the processing system is configured to:
determine whether any unassigned nodes remain; and
while any unassigned nodes remain, redefine the next subset as the current subset, and repeat steps (f) and (g) with a new next subset.

12. The system of claim 10, wherein to execute step (g), the processing system is configured to add an edge between a node of the current subset and a node of the next subset for which the node of the current subset is constrained to precede the node of the next subset and for which the node of the current subset and the node of the next subset are not conditionally independent given a second node from the current subset.

13. The system of claim 10, wherein to execute step (g), the processing system is configured to add an edge between a node of the current subset and a node of the next subset for which the node of the current subset is constrained to precede the node of the next subset and for which the node of the current subset and the node of the second subset are those that represent tasks that co-occur most often.

14. The system of claim 10, wherein the processing system is configured to add and/or delete edges between nodes to ensure that every pair of nodes in the next subset has either exactly the same set of parents in the current subset or no parents in common in the current subset.

15. The system of claim 10, wherein to execute step (d), the processing system is configured to add join nodes and split nodes to thereby connect selected nodes of the set of nodes.

16. The system of claim 15, wherein the split nodes separate subsets of nodes such that either:
nodes in each subset represent tasks that are executable in parallel without order constraints relative to tasks represented nodes of another subset; or
nodes in each subset represent tasks are mutually exclusive.

17. A computer readable medium comprising executable instructions for generating a workflow graph representative of a process to facilitate an understanding of the process, wherein said executable instructions comprise instructions adapted to cause a processing system to execute steps comprising:
(a) obtaining data corresponding to multiple instances of a process, the process including a set of tasks, the data including information about order of occurrences of the tasks;
(b) analyzing the occurrences of the tasks to identify order constraints among the tasks;
(c) partitioning a set of nodes representing tasks into a series of subsets, such that no node of a given subset is constrained to precede any other node of the given subset unless said pair of nodes are conditionally independent given one or more nodes in an immediately preceding subset, and such that no node of a following subset is constrained to precede any node of the given subset; and
(d) connecting one or more nodes of each subset to one or more nodes of each adjacent subset with an edge based upon the order constraints and based upon conditional independence tests applied to subsets of nodes, thereby constructing a workflow graph representative of the process wherein nodes represent tasks and nodes are connected by edges.

18. The computer readable medium of claim 17:
wherein for executing step (c), the executable instructions comprise instructions for
(e) analyzing the order constraints to identify one or more nodes that have no preceding nodes, and assigning the one or more nodes to a current subset, wherein nodes other than those assigned are unassigned nodes, and
(f) analyzing the order constraints for the unassigned nodes to identify one or more further nodes that have no preceding nodes from among the unassigned nodes or pass a conditional independence test with respect to those preceding nodes, and assigning the one or more further nodes to a next subset, and updating the unassigned nodes; and
wherein for executing step (d), the executable instructions comprise instructions for
(g) connecting a node of the current subset to a node of the next subset based upon the order constraints and based upon conditional independence tests applied to pairs of nodes from the current subset and the node of the next subset.

19. The computer readable medium of claim 18, wherein the executable instructions comprise instructions for:
determining whether any unassigned nodes remain; and
while any unassigned nodes remain, redefining the next subset as the current subset, and repeating steps (f) and (g) with a new next subset.

20. The computer readable medium of claim 18, wherein for executing step (g), the executable instructions comprise instructions for adding an edge between a node of the current subset and a node of the next subset for which the node of the current subset is constrained to precede the node of the next subset and for which the node of the current subset and the node of the next subset are not conditionally independent given a second node from the current subset.
